(19) United States
(12) Patent Application Publication
(10) Pub. No.: US 2011/0300507 A1
(43) Pub. Date: Dec. 8, 2011

(54) ELASTICALLY FLEXIBLE COUPLING BODY

(76) Inventors: Udo Kirstgen, Ingersheim (DE); Michael Thoms, Bietigheim-Bissingen (DE)

(21) Appl. No.: 12/282,091

(22) PCT Filed: Jan. 23, 2007
(86) PCT No.: PCT/US07/02010

§ 371 Date: Aug. 26, 2011

Related U.S. Application Data
(63) Continuation-in-part of application No. 11/342,094, filed on Jan. 26, 2006, now Pat. No. 7,565,008.
Application No. 11/342,094 is a continuation-in-part of application No. 09/992,942, filed on Nov. 5, 2001, now Pat. No. 7,016,532.
(60) Provisional application No. 60/317,521, filed on Sep. 5, 2001.
(60) Provisional application No. 60/246,295, filed on Nov. 6, 2000.

(51) Int. Cl. A61C 3/00

(52) U.S. Cl. 433/119; 433/126; 433/118; 433/122

(57) ABSTRACT

The invention relates to a coupling body that can convert a linear input movement into a linear output movement transversal to the input movement. The coupling body includes two parallel flexional arms of the same length, the ends of the flexional arms being connected by means of transversal connection arms. The connection arms carry driving bodies which represent load bodies arranged at the same distance from the neutral lines of the connection arms, in the same direction.

The invention relates to an elastically flexible coupling body for high-frequency tools, according to the preamble of Claim 1.

The term ‘high-frequency’ in the claims and in the description is to be understood to mean a frequency that amounts to from a few kHz up to 40 kHz and more. For common dental applications, it may preferentially lie within the range from 15 kHz to 25 kHz.

A high-frequency tool for dental purposes is described in DE 42 38 384 A1. Said tool includes an ultrasonic drive unit which includes an extended stack of piezoelectric discs in series. This stack of discs is accommodated in a handle of the tool. The coupling body takes the form of a ring oscillator which exhibits four oscillation maxima equally distributed in the circumferential direction. One of the oscillation maxima is connected to the ultrasonic drive unit; an oscillation maximum that is offset by 90° relative thereto is connected to the tool. The latter consequently executes a motion, the direction of which is tilted by 90° in relation to the direction of the driven motion of the ultrasonic drive unit.

Tools of the type considered above find application, in particular, in the dental field, in order to clean tooth surfaces or alternatively to generate cavities in teeth.

In this connection the coupling bodies have to exhibit relatively small dimensions, in order to enable a dentist to have a good view of the respective working site even under the cramped conditions in the mouth of a patient. The annular coupling bodies according to the state of the art, exhibiting small diameters, work reliably only when they have been worked in highly precise manner and have been produced from special, expensive materials. If these conditions are not adhered to, fractures in the coupling body—and hence a failure of the tool—may occur.

By means of the present invention, a coupling body according to the preamble of Claim 1 is to be developed further in such a way that it can be produced more easily and is less inclined towards material fractures.

In accordance with the invention, this object is achieved by means of a coupling body having the features specified in Claim 1.

In the case of the coupling body according to the invention, excitation of the natural oscillations is effected by virtue of the fact that a torque is caused to act at a predetermined point on the flexural arms. This torque is generated by a force which acts on the driven flexural arm or arms under a lever arm.

Advantageous further developments of the invention are specified in dependent claims.

According to Claim 2, a particularly effective excitation of the natural oscillations of the flexural arms is obtained, since the driving tilting motion is fed in at a point on the flexural arm at which the latter exhibits a s node of a natural oscillation.

The further development of the invention according to Claim 3 is advantageous with regard to symmetrical oscillation conditions and symmetrical loads of the driven flexural arm or arms.

With the further development of the invention according to Claim 4, it is ensured that a non-driven flexural arm also oscillates and is loaded symmetrically in relation to a transverse median plane of the arm.

A coupling body according to Claim 5 has two flexural arms with drive bodies mounted in the same direction of rotation and acting as mass bodies, the centres of gravity of which are in each instance remote from the neutral fibre of the flexural arm carrying them. If the flexural arms have a force applied to them in the longitudinal direction, the drive bodies mounted with spacing and acting as mass bodies result, by reason of their inertia, in flexures, in the same direction of rotation, of the two flexural arms.

Since the two driven ends and the two free, driving ends of the flexural arms are connected by connecting arms, at the driving ends of the flexural arms a motion of the connecting arm situated there is obtained that is perpendicular to the longitudinal direction of the two flexural arms and hence also perpendicular to the drive motion, parallel hereto, which is imposed on the connecting arm connecting the driven ends of the flexural arms.

A coupling body according to Claim 2 can consequently be regarded as a frame with flexible parallel sides which carry drive bodies which are mounted with spacing from the edges of the frame and which act as mass bodies. The coupling body consequently forms an elastically deformable parallelogram linkage with mounted drive bodies acting as mass bodies, which have the result that a high-frequency imposed linear reciprocating input motion is converted into a substantially linear reciprocating output motion having the same frequency, which is tilted relative to said input motion.

The further development of the invention according to Claim 6 is advantageous with regard to adjusting the loads and conditions of movement in both flexural arms to be the same.

In the case of a coupling body according to Claim 7, for the moment of inertia generated by one of the drive bodies it is possible to profit from the transverse dimension of the frame spanned by the various arms. The mass of the one drive body can therefore be chosen to be somewhat smaller.

In this connection, according to Claim 8 the torques that the drive bodies acting as mass bodies exert on the flexural arms when the frame constituted by flexural arms and connecting arms is accelerated can be adapted to one another, despite differing masses of the drive bodies.

The further development of the invention according to Claim 9 is advantageous with regard to compact dimensions of the coupling body.

The further development of the invention according to Claim 10 is advantageous with regard to smooth boundary surfaces of the coupling body.

A coupling body according to Claim 11 is distinguished in that accelerations of the frame constituted by flexural arms and connecting arms in the direction of the axes of the flexural arms are converted particularly effectively into flexural oscillations.

In this connection, according to Claim 12 particularly large dimensions can be given to the drive body situated inside the frame.

The further development of the invention according to Claim 13 is also advantageous with regard to a strong generation of flexural oscillations. Correspondingly strong are the drive motions derived therefrom in the direction of the tool axis, which are provided by the tool-side connecting arm.

Claim 14 specifies a particularly simple and reliable possibility for the connection of sonotrode and coupling body.

A coupling body according to Claim 15 permits the unit constituted by coupling body and driven end of the sonotrode to be of particularly short construction in the direction perpendicular to the plane of the frame.

The further development according to Claim 16 also serves for a uniform distribution of the mechanical loads on both flexural arms.

The further development of the invention according to Claim 17 is advantageous with regard to a precise and reliable initiation of the drive motion and with regard to a precise and safe movement of the tool.

This applies to an increased extent to a coupling body according to Claim 18.

In the case of a coupling body according to Claim 19, the geometry assumed in the force-free state is a rectangle. The deflections of the flexural arms take place symmetrically towards both sides of the rectangle edges constituted by them, as a result of which a residual motion component parallel to the input, motion, which remains in the case of a relatively large deflection of the flexural arms, can be kept very small or, in the case of small deflections such as are of interest here, is practically zero.

The further development of the invention according to Claim 20 is advantageous with regard to the avoidance of local stresses in the material of the coupling body.

In the case of a coupling body according to Claim 21, the mass bodies and the connecting arms may be situated substantially in the same plane, without the drive body situated inside the frame impeding the deformation of the frame. In consequence, a coupling body can be produced in a straightforward manner starting from a plane-parallel blank.

The further development of the invention according to Claim 22 is advantageous with regard to a simple and is secure fastening of the tool to the driving part of the coupling body.

With the further development of the invention according to Claim 23, it is ensured that the coupling body is of particularly slender construction in the vicinity of the tool. This is advantageous with regard to good visual contact with the working site.

According to Claim 24, a simple and loadable connection of the coupling body to the drive unit is obtained. The latter may be constituted, for example, simply by an ultrasonic generator or by an ultrasonic generator with downstream sonotrode.

The further development of the invention according to Claim 25 is once again advantageous with regard to favourable ergonomics of the tool that has been realised with the coupling body.

The further development of the invention according to Claim 26 is advantageous from a like the regard to the producibility of the coupling body from a plane-parallel blank. Furthermore, the rectangularly prismatic basic geometry of the flexural arm permits the frequencies of oscillation to be calculated precisely in advance. Lastly, the flexural oscillations are accurately predetermined by the rectangular shape: the oscillations induced in the flexural arms are largely free from torsions with respect to the longitudinal axis of the flexural arms.

The aforementioned advantages apply to an increased extent to a coupling body according to Claim 27 and to one according to Claim 28.

The further development of the invention according to Claim 29 is advantageous with regard to compact construction of the coupling body and of a handpiece containing it in the vicinity of the working site. This facilitates both the handling under spatially cramped conditions and the visual contact with the working site.

A coupling body according to Claim 30 is distinguished by particularly long service life.

The invention will be elucidated in more detail below on the basis of exemplary embodiments with reference to the drawing. Shown therein are:

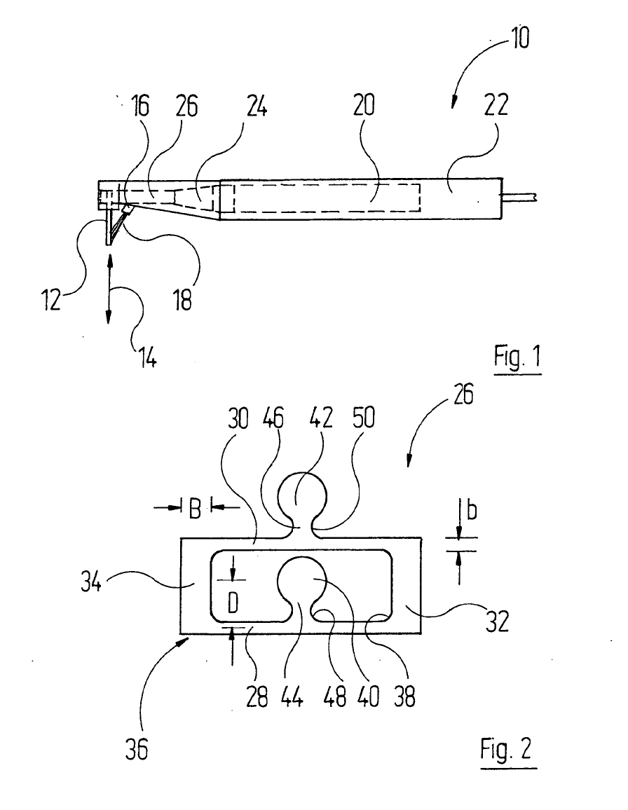

FIG. 1: a side view of a dental ultrasonic handpiece, in which the various principal components of the handpiece are indicated schematically;

FIG. 2: a side view of a coupling body that can be used in an ultrasonic handpiece according to FIG. 1;

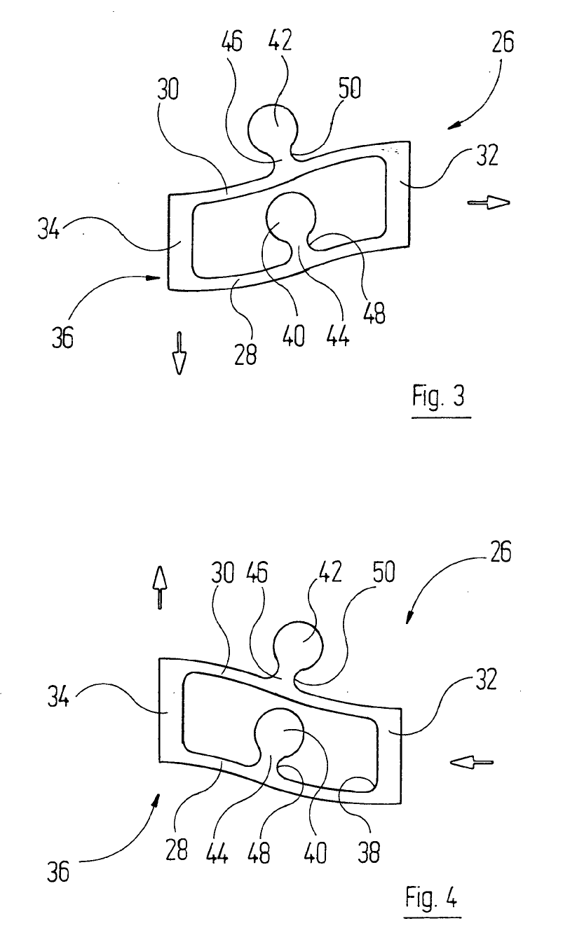

FIG. 3: a schematic view of the coupling body according to FIG. 2 in a motion phase in which a pulling force directed towards the right in the drawing is exerted on the coupling body;

FIG. 4: a view similar to that of FIG. 3, wherein, however, a pushing force directed towards the left in the drawing is exerted on the coupling body;

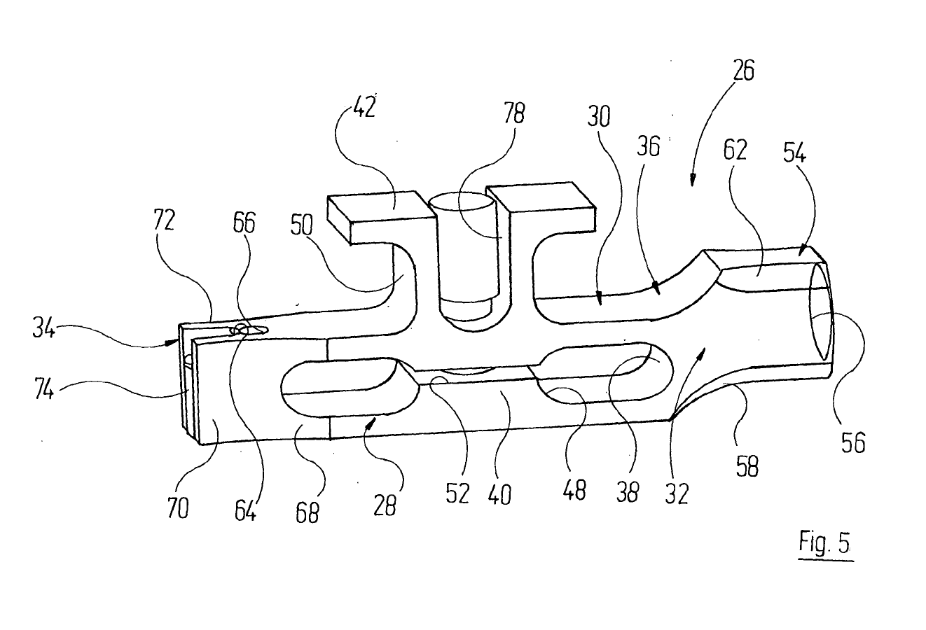

FIG. 5: a perspective view of a practical embodiment of a coupling body for a tool according to FIG. 1;

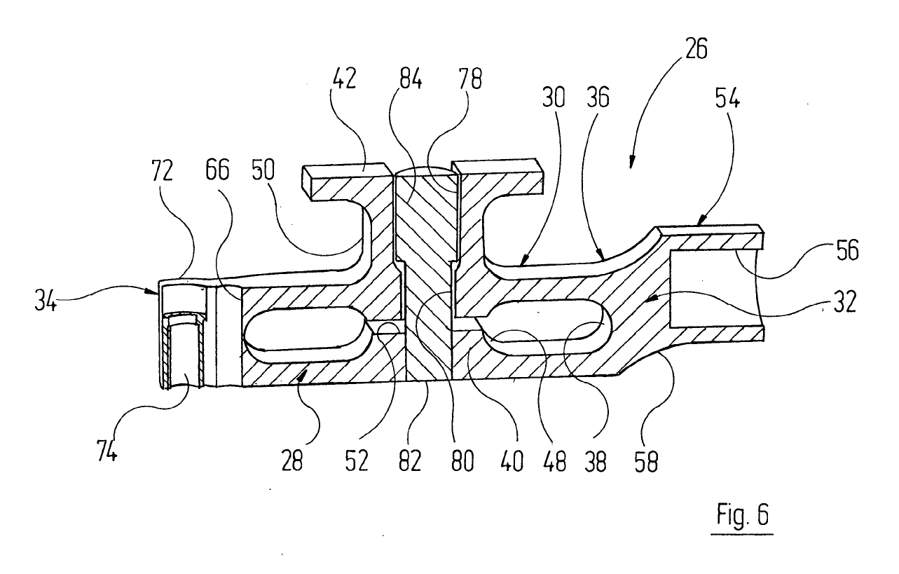

FIG. 6: a longitudinal section through the coupling body according to FIG. 6;

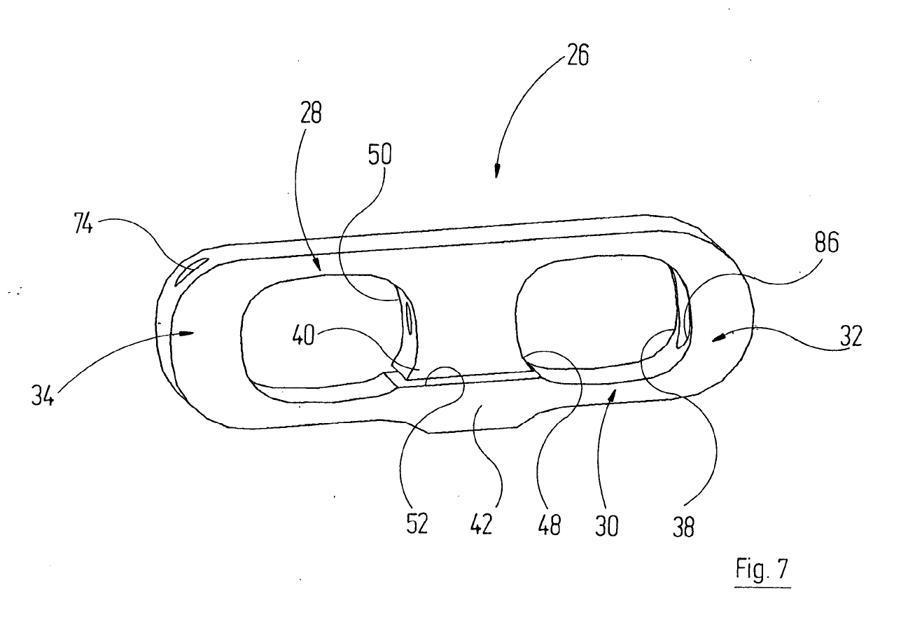

FIG. 7: a perspective view of a further modified coupling body;

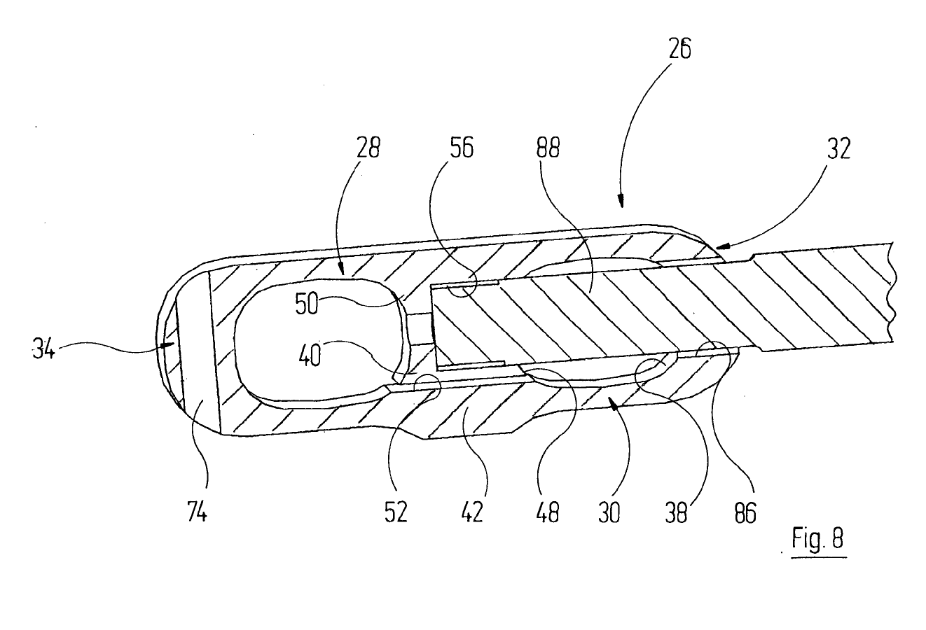

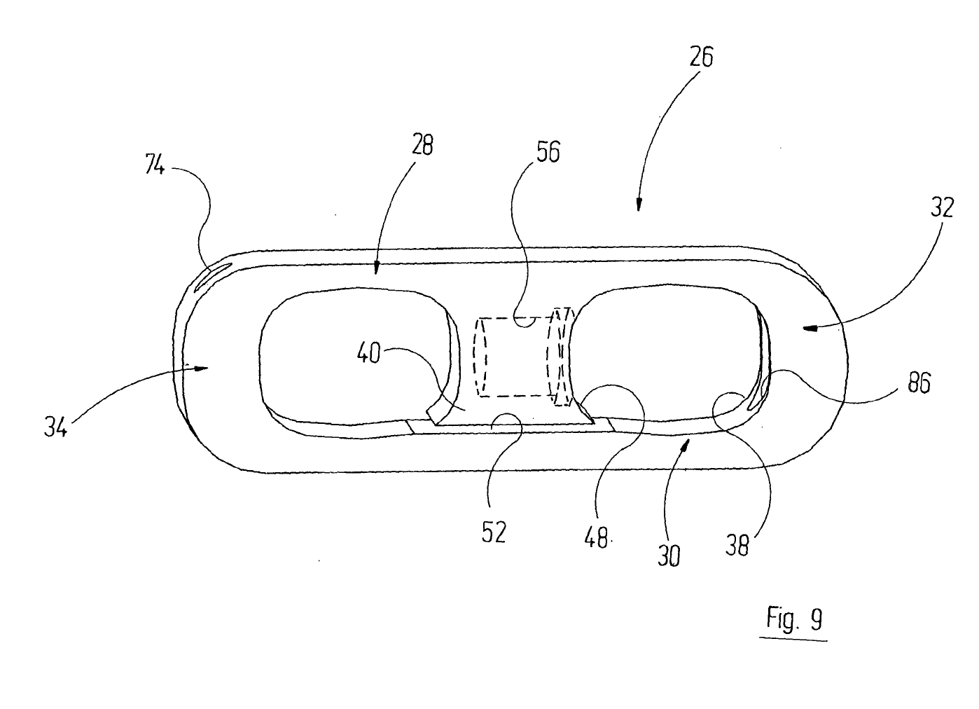

FIG. 8: a median section through the coupling body according to FIG. 7 together with the driven end a sonotrode; and

FIG. 9: a view similar to that of FIG. 7, in which a coupling body that has again been modified is reproduced.

Denoted overall by 10 in FIG. 1 is an ultrasonic handpiece that serves for driving a tool 12.

In the case of the tool 12, it may be a question, for example, of a lancet-shaped flat tool with which the lateral faces of a tooth are to be machined. The tool 12 is moving in the direction of the arrow 14 which is indicated in the drawing. During working with the tool 12, a jet 18 of a working fluid is directed onto said tool through a nozzle 16, said fluid containing an abrasive medium suspended in water.

For the purpose of generating the vertical to-and-fro motion of the tool 12 in FIG. 1, the amplitude of which amounts to a few 10 μm to 100 μm, use is made of an ultrasonic generator 20 which is accommodated inside a handle 22 of the handpiece 10. The ultrasonic generator 20 includes a plurality of piezoelectric discs stacked in succession in the axial direction and is connected at its driven end, situated on the left in FIG. 1, to a sonotrode 24. The latter serves to concentrate the ultrasonic energy by ‘funnel action’ and to make a correspondingly enlarged amplitude of motion available at the output.

The end of the sonotrode 24 is connected to a coupling body 26. The latter converts the driven motion of the sonotrode 24, which is directed in the axial direction of the handle 22 and which is horizontal in the drawing, into a motion of the tool 12 that is perpendicular to the axis of the handle 22 and vertical in the drawing.

FIG. 2 shows schematic structure of the coupling body 26. Said body has two equally long flexural arms 28, 30, is parallel to one another, which each have a rectangular cross-section, the long side of the cross-section being perpendicular to the plane of the drawing of FIG. 2. The ends of the flexural arms 28, 30 are closed by connecting arms 32, 34 so as to form a rectangular frame 36, the inner edge of which exhibits quadrant-shaped roundings 38 at the corners.

Perpendicular to the plane of the drawing of FIG. 2 the connecting arms 32, 34 have the same dimensions as the flexural arms 28, 30 but have a width B which is distinctly greater than the width b of the flexural arms. The connecting arms 32, 34, which incidentally are also shorter, may therefore be regarded as being substantially rigid in comparison with the flexural arms 28, 30.

The connecting arms 32, 34 carry at their middle identical drive bodies 40, 42 acting as mass bodies, the centres of gravity of which are remote from the neutral fibres of the flexural arms 28, 30 by the same spacing D in the upward direction. The drive bodies 40, 42 likewise have the same dimension perpendicular to the plane of the drawing of FIG. 2 as the flexural arms 28, 30 and the connecting arms 32, 34. The entire coupling body 26 can consequently be produced by being sawn out of a plane-parallel blank.

The drive bodies 40, 42 acting as mass bodies have substantially the shape of axially short cylinders and are connected to the adjacent connecting arms 32, 34 via transition portions 44, 46.

The transition portions 44, 46 are connected at their two sides to the flexural arms 28, 30, in each instance via roundings 48, 50.

Under operational conditions the connecting arm 32 which is situated on the left in the drawing is connected to the tool 12 via a collet chuck which is not represented, whereas the connecting arm 34 which is situated on the right in the drawing is connected to the driven portion of the sonotrode 24 via a connecting head which is not represented in FIG. 2.

In FIGS. 3 and 4 it is shown how the coupling body is deformed when a pulling force directed to the right, and a pushing force directed to the left, respectively, is exerted on the connecting arm 34 which is situated on the right in the drawing.

If, as represented in FIG. 3, a force directed to the right is exerted on the connecting arm 34, the inertia of the drive bodies 40, 42 has the result that the flexural arms 28, 30 become curved downwards. Since the drive bodies 40, 42 are exactly the same as far as their geometry, their material and their weight are concerned, the two flexural arms 28, 30 are bent downwards in the same way. Since their lengths remain constant and their free ends move identically, the connecting arm 32 situated on the left in the drawing is moved downwards parallel to the connecting arm 34.

If, on the other hand, a force directed to the left is exerted on the right-hand connecting arm 34, then on account of the inertia of the drive bodies 40, 42, in a manner similar to that described above, a flexure—in the same direction of rotation and of the same magnitude —of the flexural arms 28, 30 occurs upwards, and hence a motion of the connecting arm 32 upwards in a direction exactly parallel to the extent of the connecting arm 34.

It will be discerned that the coupling body 26 consequently converts a reciprocating motion exerted on the driven connecting arm 34 situated on the right, which takes place in the axis of the sonotrode 24 and hence in the axis of the ultrasonic generator 20 and of the handle 22), into a motion of the tool that takes place perpendicular to the axis of the sonotrode 24 and hence to that of the handle 22.

From FIGS. 2 to 4 it is evident that the drive body 40, which is situated inside the frame 36 and is carried by the lower flexural arm 32, is so far removed from the upper flexural arm 34 situated outside the frame 36 that the flexural motion thereof is not impaired. Since, as stated, both flexural arms 28, 30 are deflected in the same direction and by the same amounts, this spacing between the drive body 40 and the flexural arm 30 does not need to be large.

FIGS. 5 and 6 show a practical exemplary embodiment of a coupling body 26. Parts of the coupling body 26 that correspond, from the point of view of function, to corresponding parts already above with reference to FIGS. 2 to 4 are again provided with the same reference symbols and do not need to be described again in detail in terms of their basic properties.

The coupling body 26 according to FIG. 5 can be produced from a plane-parallel blank by two elongated holes, which are each terminated at their ends by a semicylindrical surface 48, being produced in it in the region of the flexural arms 28, 30. In the web remaining between the two elongated holes a slot, 52 is then produced by milling, as a result of which a lower drive-body base 40 is obtained.

Similarly, in an upper portion of the blank two further elongated holes are generated which are terminated, by flattened semicylindrical surfaces 50 and of which the left-hand one is opened upwards and to the left in such a way that the bottom surface of the elongated hole is continued as far as the free horizontal end of the coupling body 26 and the elongated hole is opened upwards shortly before the right-hand end face of the elongated hole.

Similarly, the upper portion of material above the right-hand elongated hole of FIG. 5 is also milled away, in such a manner that a substantially T-shaped drive body 42 is obtained.

Moulded on the connecting arm 34, situated on the right, of the coupling body is a connecting head 54 which exhibits a threaded bore 56 which is open towards the right and into which an end portion of the sonotrode 24, which is provided with thread, can be screwed.

An upper boundary surface of the connecting head 54 and a lower boundary surface of this connecting head are situated in such a way that the bore 56 situated centrally in the connecting head is situated approximately at the height of the upper flexural arm 30. The transition surfaces of these upper and lower boundary surfaces to the actual coupling body are curved, as indicated at 58 and 60 in the drawing. The edges of the connecting head 54 are broken by bevels 62.

The end portion of the coupling body 26 that is situated on the left in FIG. 5 exhibits a central vertical slot 64 which leads to a vertical bore 66. In the region situated on the left, the outside of the connecting arms 32, 34 are each provided, symmetrically in relation to the longitudinal median plane, with a chamfer 68, so that clamping portions 70, 72 of the connecting arm 34 situated on the left are obtained.

Parallel to the bore 66, an axially slotted receiving sleeve 74 is inserted into the connecting arm 32, into which the shaft of a tool can be inserted.

By means of a clamping screw, which is not represented, the clamping portions 70, 72 can be moved towards one another, contrary to their spring force, in order to clamp the shaft of a tool firmly in the receiving sleeve 74.

The upper drive body 42 has a central vertical slot 78 which is open in the direction towards its upper end face, in the bottom of which a through-bore 80 is provided. The latter is flush with a fastening bore 82 in the drive-body base 40.

The shaft of a mass rod 84 which extends, with lateral clearance, through the through-bore 80, and the slot 78 is firmly inserted (welded) into the fastening bore 82, so that the mass rod 84 does not impinge laterally even when the coupling body 26 is subjected to ultrasound.

The end face of the mass rod 84 and the upper side of the drive body 42 are substantially coplanar.

The geometry and mass of the drive-body base 40 and of the mass rod 84 are so chosen that the common moment of inertia with respect to the region of attachment to the flexural arm 28 is substantially equal to the moment of inertia of the drive body 42 in relation to its region of attachment to the flexural arm 30.

In terms of function, the coupling body 26 according to FIGS. 5 and 6 corresponds to that according to FIGS. 2 to 4.

Titanium is used as material for the coupling body 26 and where appropriate, its parts.

FIGS. 7 and 8 show a modified coupling body 26 which is of more compact construction in the direction perpendicular to the axis of the flexural arms 28, 30.

Components that have already been described with reference to the preceding Figures are provided with the same reference symbols, even when they are geometrically somewhat differently shaped, provided that they correspond functionally.

The drive body 42 protruding outwards beyond the frame of the coupling body 26 is reduced in size and projects only quite slightly into the interior of the frame. The drive body 40 projecting into the interior of the frame is continued with its flat end face up until a short distance before the inside of the flexural arm 30.

The drive body 40 serves as coupling portion for a s sonotrode. To this end, the threaded bore 56 is provided in it. Furthermore, a through-bore 86 is provided in the connecting arm 32, through which a drive portion 88 of the sonotrode 24 is able to extend with clearance.

The axis of the bore 86 runs parallel to the flexural arms 28, 30 and centrally between the latter, so that the driven portion 88 acts on the flexural arm 28 under a lever arm (via the drive body 40). On account of this geometry of the application of force, a good stimulation of oscillation of the coupling-body frame constituted by the flexural arms 28, 30 and the connecting arms 32, 34 is guaranteed, although the drive bodies 40, 42 exhibit distinctly reduced mass in comparison with the other exemplary embodiments.

The coupling body 26 according to FIGS. 7 and 8 is distinguished by particularly compact. structure and good redirection of the input motion into a driven motion extending inclined at 90° in relation to said input motion.

The coupling body according to Claim 9 largely resembles that according to FIG. 7.

But the drive body 42 has now disappeared, and the end face of the drive body 40 has once again moved closer to the inner surface of the flexural arm 30, as close as is possible in terms of manufacturing engineering.

Production is effected in such a way that a plate-like blank is milled with the desired outer contour, and two apertures with the roundings 38, 48 are generated in it, whereby firstly a central continuous web remains which later forms the drive body 40. Into the intermediate product obtained in such a way, the shape of which substantially corresponds to an ‘8’, the through-bore 86 is then drilled, and the threaded bore 56 which is aligned therewith is sunk.

Then the slot 52 is produced by milling, as closely as possible in terms of manufacturing engineering, at the inside of the flexural arm 30 with a narrow disc-milling cutter.

The flexural arm 28 has, by reason of the drive body 40 carried by it, a different oscillatory behaviour from that which a flexural arm exhibiting an identical cross-section without mounted drive body would have.

In order to compensate for this difference, the flexural arm situated at the bottom in FIG. 9 is approximately 25 percent wider (dimension in the vertical direction in FIG. 9) than the flexural arm 28. In this way, both flexural arms 28, 30 have the same natural frequency and oscillate with their ends adjacent to the connecting arm 34 in phase with identical amplitude.

In a practical exemplary embodiment, the coupling body 26, measured in the longitudinal direction (in the drawing, in the horizontal direction), has an overall dimension of 24.2 mm; measured in the transverse direction (in the drawing, the vertical direction), the lower boundary surface of the coupling body 26 has a spacing from the longitudinal axis of the same that amounts to 4 mm, whereas the upper outer surface of the coupling body 26 exhibits a spacing from the longitudinal axis of only 3.6 mm. The difference in spacing corresponds to the enlarged transverse dimension of the flexural arm 30 which is situated at the bottom in FIG. 9,

In this practical exemplary embodiment the thickness of the plate from which the coupling body 26 has been produced amounts to 5 mm, the diameter of the through bore 86 amounts to 4 mm, and the diameter of the threaded bore 56 amounts to 3.5 mm.

Titanium serves as material for the coupling body 26.

1. Elastically flexible coupling body for coupling a drive unit (20, 24) with a tool (12), which body converts an input motion taking place along an input axis into an output motion taking place along an output axis different from the input axis, characterised in that it exhibits two parallel flexural arms (28, 30) of equal length which are connected at their ends by transverse connecting arms (32, 34), and in that a high-frequency flexural force is applied on at least one of the flexural arms (28, 30) under a lever arm.

2. Coupling body according to claim 1, characterised in that the flexural force is applied at a node of a natural oscillation of the flexural arm (28) moved by it.

3. Coupling body according to claim 2, characterised characterised in that the flexural arm (28) which is moved by the flexural force is symmetrical, substantially to a transverse median plane of the arm and the flexural force is applied in the median plane of the arm.

4. Coupling body according to claim 3, characterised in that the second flexural arm (30) is also substantially symmetrical to a transverse median plane of the arm.

5. Coupling body according to one of claims 1 to 4, characterised in that the flexural arms (28, 30) carry drive bodies (40, 42; 40, 42, 84) constituting mass bodies that are transversely eccentric in the same direction of rotation.

6. Coupling body according to claim 5, characterised in that the moments of inertia of the drive bodies (40, 42; 40, 42, 84) constituting mass bodies with respect to their region of attachment to the associated flexural arm (28, 30) are substantially identical.

7. Coupling body according to claim 5 or 6, characterised in that the centres of gravity of the drive bodies (40, 42, 84) constituting mass bodies are variably remote from the respectively associated flexural arm (28, 30).

8. Coupling body according to claims 6 and 7, characterised in that and the masses of the drive bodies (40, 42, 84) constituting mass bodies are different, corresponding to their different spacing from the respectively associated flexural arm (28, 30).

9. Coupling body according to one of claims 5 to 8, characterised in that the drive bodies (40, 42, 84) constituting mass bodies are transversely nested.

10. Coupling body according to one of claims 5 to 9, characterised in that the end faces of both drive bodies (40, 42, 84) constituting mass bodies are substantially parallel to one another, are preferentially coplanar.

11. Coupling body according to one of claims 5 to 10, characterised in that the drive bodies (40, 42) constituting mass bodies extend outward in the same absolute direction from the associated flexural arms (28, 30), so that a first (40) of the drive bodies (40, 42) Projects into the interior of the frame constituted by flexural arms (28, 30) and connecting arms (32, 34), whereas the second (42) of the drive bodies (40, 42) protrudes beyond the clear contour of the frame constituted by flexural arms (28, 30) and connecting arms (32, 34).

12. Coupling body according to one of claims 5 to 10, characterised in that both drive bodies (40, 42) have the same geometry, preferentially that of circular discs.

13. Coupling body one of claims 1 to 4, characterised in that a drive body (40) which is carried, extending transversely, by one (28) of the flexural arms (28, 30) is provided with connecting means (56) to which a driven portion (88) of a sonotrode (24) is capable of being coupled.

14. Coupling body according to claim 13, characterised in that the connecting means (56) exhibit a threaded bore.

15. Coupling body according to claim 13 or 14, characterised in that a first (32) of the connecting arms (32, 34) is provided with a through-hole (86) parallel to the flexural arms (28, 30), through which the driven portion (88) of the sonotrode (24) is capable of being passed with clearance.

16. Coupling body according to one of claims 1 to 15, characterised in that the flexural arms (28, 30) exhibit such an edge contour and/or such a cross-section that they have the same frequency of oscillation and their output-side ends oscillate in phase.

17. Coupling body according to one of claims 1 to 16, characterised in that the connecting arms (32, 34) exhibit great flexural stiffness compared with the flexural stiffness of the flexural arms (28, 30).

18. Coupling body according to claim 17, characterised in that the connecting arms (32, 34) are substantially rigid.

19. Coupling body according to one of claims 1 to 18, characterised in that the connecting arms (32, 34) are perpendicular to the flexural arms (28, 30).

20. Coupling body according to one of claims 1 to 19, characterised in that the drive bodies (40, 42) are connected to the sides of the flexural arms (28, 30) via curved transition surfaces (48, 50).

21. Coupling body according to one of claims 1 to 20, characterised in that the mass body (40) carried by the one (28) of the connecting arms (28, 30) and pointing towards the interior of the coupling body terminates with a small spacing before the inside of the other flexural arm (30).

22. Coupling body according to one of claims 1 to 21, characterised in that the tool-side connecting arm (34) takes the form of a collet chuck (64, 74).

23. Coupling body according to claim 22, characterised in that the tool-side connecting arm exhibits reduced thickness (68).

24. Coupling body according to one of claims 1 to 12, characterised in that the connecting arm that is capable of being connected to the drive unit (20, 24) exhibits a connecting head (54) which is provided with means (56) for coupling to the drive unit (20, 24).

25. Coupling body according to claim 24, characterised in that the connecting head (54) exhibits an axis that is substantially aligned with the median plane of one (30) of the flexural arms (28, 30).

26. Coupling body according to one of claims 1 to 25, characterised in that the basic shape of the flexural arms (28, 30) corresponds to a prism exhibiting a rectangular cross-section.

27. Coupling body according to claim 26, characterised in that the width of the cross-section of the prism is distinctly greater than the height thereof.

28. Coupling body according to claim 27, characterised in that the width of the cross-section of the prism corresponds to approximately 3 times to 6 times, preferentially approximately 4 times to 5 times, the height of the cross-section of the prism.

29. Coupling body according to one of claims 1 to 28, characterised in that the outsides of the connecting arms (32, 34) are rounded; preferentially, the outsides of the flexural arms (28, 30) are smoothly connecting cylindrical surfaces.

30. Coupling body according to one of claims 1 to 20, characterised in that it has been produced from titanium.
